(19) United States
(12) Patent Application Publication
(10) Pub. No.: US 2007/0096031 A1
(43) Pub. Date: May 3, 2007

(54) Modular radiation detector with scintillators and semiconductor photodiodes and integrated readout and method for assembly thereof

(75) Inventors: Dirk Meier, Oslo (NO); Bjorn M. Sundal, Oslo (NO)

Correspondence Address: BROWDY AND NEIMARK, P.L.L.C.;624 NINTH STREET, NW, SUITE 300, WASHINGTON, DC, 20001-5303, US

(73) Assignee: IDEAS AS, HOVIK (NO)

(21) Appl. No.: 10/561,395

(22) PCT Filed: May 6, 2004
(86) PCT No.: PCT/IL04/00381

§ 371 Date: Dec. 19, 2005

(51) Int. Cl. G01T 1/24; G01T 1/164

(52) U.S. Cl. 250/370.11; 250/363.03

(57) ABSTRACT

A modular radiation detector (10) with scintillators (13) and semi-conductor photodiodes (12) and integrated readout (15) can be used in positron emission tomography (PET) for functional imaging of humans and animals. Spatial resolution is improved by measuring the depth-of-interaction and modules using photodiodes and integrated readout circuits according to the invention instead of photo-multipliers give rise to lighter and less bulky tomographic instruments. The invention uses very large scale integrated (VLSI) electronic readout circuits for measuring signals from photo-diodes. The electronic readout circuits (15) are located on the module and allow data to be measured and processed at very high rates on the module level rather than on the system level. The use of photodiodes promises greater stability during operation and improved reliability over photo-multipliers. The invention can be used in magnetic fields and therefore allows PET and MRI/NMR imaging techniques to be combined.

### FIELD OF THE INVENTION

This invention relates to detecting radiation and measuring (imaging) its distribution in living objects. The invention can be applied in positron emission tomography (PET) where functional images are measured from patient objects. The invention describes a radiation detection module with a scintillator crystal array; and a photo-diode array, and integrated readout electronics. The invention also describes the modular assembly method (packaging in modules) and the arrangement of same in a tomographic imaging instrument.

### REFERENCES

[1] C. Moisan et al “Segmented LSO Crystals for Depth of Interaction Encoding in PET”, IEEE, Nucl. Sci. Symp. vol. 2, 1112-1116, 1997.
[2] R. S. Miyaoka et al. “Design of Depth of Interaction PET Detector Module”, IEEE, Trans. Nucl. Sci., 45(3):1069-1073, 1998.
[3] W. W. Moses et al. “Performance of a PET Detector Module Utilizing an Array of Silicon Photodiodes to Identify the Crystal of Interaction”, IEEE, Trans. Nucl. Sci., 40(4):1036-1040, 1993.
[4] M. H. Huber et al. “Characterization of a 64 Channel PET Detector using Photodiodes for Crystal Identification”, IEEE, Trans. Nucl. Sci., 44(3):1197-1201, 1997.
[5] W. D. Sekela. “Modular Radiation Detector Assembly”, U.S. Pat. No. 6,359,282, March 2002.
[6] C. S. Levin et al. “High Resolution Scintillation Detector with Semiconductor Readout”, U.S. Pat. No. 6,114,703, September 2000.
[7] J. Iwanczyk and B. Patt. “Radiation Imaging Detector”, U.S. Pat. No. 5,773,829, June 1998.
[8] J. Iwanozyk and B. Patt. “Gamma-ray detector employing scintillators coupled to semiconductor drift photodetectors”, U.S. Pat. No. 6,521,894, February 2003.
[9] D. J. Krus et al. “Precision Linear and two-dimensional Scintillation Crystal Arrays for x-ray and gamma-ray Imaging Applications”, SPIE Int. Symp. Opt. Sci., vol. 3768, 1999.
[10] S. E. Derenzo et al. “The Quest for the Ideal Inorganic Scintillator”, submitted to Nucl. Instr. Meth., 2002.
[11] K. S. Shah et al. “i LaBr3:Ce Scintillator for Gamma Ray Spectroscopy”, submitted to IEEE, Trans. Nucl. Sci., pre-print LBNL-51793, 2002.
[12] R. Hartmann et al. “Ultrathin Entrance Windows for Silicon Drift Detectors”, Nucl. Instr. Meth., A 387 (1997) 250-254.
[13] DiFillipo. “Scintillation Detector with Wavelength-shifting Optical Fibers”. U.S. Pat. No. 6,078,052, June 2000.
[14] B. E. Hammer. “NMR-PET Scanner Apparatus”, U.S. Pat. No. 4,939,464, July 1990.
[15] N. H. Clinthorne et al. “Very High Resolution Animal PET”, Soc. Nucl. Med., St Louis, Mo. Jun. 3-7 (2000), 47th Annual Meeting.
[16] E. Nygard and Y. Tsutomu “Discriminator Circuit for a Charge Detector”, U.S. Pat. No. 6,509,565, January 2003.
[17] Ideas ASA “Readout circuit for a multi-pixel sensor” PCT/IL03/00126 filed Feb. 18, 2003 and due to be published September 2003.

### BACKGROUND OF THE INVENTION

In state-of-the-art positron emission tomography two 511-keV photons from a positron annihilation are measured in two scintillator crystals where the crystals emit light in response to the photon interaction. The scintillation light is measured in photo-multiplier tubes that are optically coupled to the crystals. The photo-multipliers generate an electrical current that can be measured by an electronic circuit. Signal amplitudes and time of interaction are measured for many positron annihilations. The measurements are used to derive an image of the positron distribution. Current PET scintillators have a fast and sufficient light yield at a wavelength suitable for photo-multipliers. The mass density, total mass and volume of the scintillator are chosen to support a certain detection efficiency. Current photo-multipliers measure the scintillation light with a reasonable signal-to-noise ratio. The basic performance criteria for a tomograph are detection efficiency, and spatial resolution in the image. The performance criteria depend on timing resolution, and energy resolution, which are closely linked to the scintillator material, the photo-multiplier, and the readout electronics and the overall assembly on a module and system level.

There are technical and fundamental aspects that determine the detection efficiency and the spatial resolution in PET. Aspects of position resolution in PET are:

1. Modes of photon interaction in matter: For 511-keV photons the modes of interaction include Compton scattering and photo-absorption. There are photons interacting in the patient object and there are photons that leave the patient object and directly interact in the tomograph. A good energy resolution in the tomograph allows one to discriminate patient scattered photons from direct photons. In case of photo-absorption all photon energy is transferred to a photo-electron, which travels inside the crystal releasing its kinetic energy and thereby blurring the positions measured. In the case of Compton scattering, the 511-keV energy splits between a Compton electron and the scattered photon. The scattered photon may traverse several crystals and eventually gets absorbed or re-scatters. Signals from a Compton scattered event are difficult to relate to its first point of interaction and the positions measured are blurred.

2. Missing depth-of-interaction: Photo-multipliers in PET are optically coupled to one side of the scintillator crystal where the photo-multiplier “views” tile crystal along one axis. The point of photon interaction can be measured perpendicular to this axis with an accuracy that depends on detector segmentation and reconstruction algorithms. However, the point of interaction along this axis cannot be measured using conventional techniques. This is the problem of the missing depth-of-interaction in PET. There are attempts to measure the depth-of-interaction [1,2].

3. Acollinearity: There, are various modes and stages of positron annihilation. For any mode of annihilation there are finally two 511-keV photons emitted. The angle of emission measured in the laboratory coordinate system differs from 180° where the difference is less than 0.5 degree and varies at random. This is the acollinearity of the annihilation process. The acollinearity limits spatial resolution in PET.

4. Positron kinetic energy: Positrons are emitted by decaying isotopes with certain kinetic energy. Positrons traverse a distance in tissue until they annihilate and the distance depends on the kinetic energy. The spatial resolution in the tomographic image is ultimately limited by the distance between creation and annihilation of positrons in the tissue. Positron emitting isotopes are known whose end-point energy is as low as 0.64 MeV for Fluor-18 with 0.5-mm mean distance of travel in human tissue.

5. Timing resolution: Two interactions in the tomograph are assigned to one positron annihilation when they are measured within the coincidence time window. The coincidence time window starts with any of two interactions and ends after a time that is characteristic for the tomograph. There are true coincidences where both 511-keV photons belong to the same positron annihilation. There are random coincidences where the two 511-keV photons do not belong to the same positron annihilation. The number of random coincidences increases as the coincidence time window increases. A short coincidence time window is important to discriminate true coincidences from random coincidences. The scintillator light response and decay time should be of the order of nanoseconds and the photo-multiplier and the triggering electronics should likewise respond within nano-seconds. While it is important to consider the time needed to transmit signals along cables (1 ns per 30 cm) it is also important to consider the time of the 511-keV photons to reach the detectors (time-of-flight, 1 ns per 30 cm.)

Aspects of detection efficiency: The probability of photon interaction in matter depends on its atomic number, and on its mass density, and on the overall thickness. Scintillator materials for 511-keV PET have high atomic number and high mass density and the thickness is chosen so as to optimize photon interaction in the scintillator. A photon interaction in the scintillator can be measured with an intrinsic spatial resolution that is proportional to the dimensions of the crystals.

Additional considerations for PET instrumentation are 1. the stability with respect to temperature and electromagnetic fields, 2. the geometry, size and weight of scintillators and photo-multipliers, 3. the complexity of the measuring instrument and its assembly, 4. the functional image information and its location within the patient, which leads to PET combined with alternate imaging modalities.

However, it has been proposed to replace photo-multipliers in order to improve overall system performance. There are proposals to replace photo-multipliers by semiconductor sensors [6], by photo-diodes [7] and by drift photo-detectors [8]. There are proposals for modular radiation detector assemblies [3, 4, 5] using scintillators coupled to photodiodes. Recent progress in scintillator array manufacture and processing techniques [9, 10] and progress in low-leakage current silicon photo-diode processing techniques allow the construction of radiation detection modules without photo-multipliers, thereby avoiding the disadvantages associated therewith. However, such detector modules still currently suffer from the drawback that in use they provide no indication of depth of interaction of an incoming photon. This is similar to conventional photo-multipliers where an incoming photon reacts with a scintillator element that causes light to be emitted and propagated axially through an adjacent photo-multiplier. The photo-multiplier is essentially a tubular element that provides no information as to where a photon strikes the bulk of the detector since only a single scintillator element is associated with each photo-multiplier, at an entry window thereto.

Modules based on photodiode readout allow the assembly of detection modules with smaller pixels, higher integration, and more compact assemblies. The scintillator material, the photodiode as well as the readout circuit must be optimized. There are new scintillator materials with fast and high light output [11], however, the wavelength of emission does not ideally match custom photodiodes. Photodiodes can be processed to accommodate the wavelength of emission of new scintillators [12]. Alternatively or additionally layers of optical coupling may be used in between scintillators and photodiodes in order to match the wavelength and refractive indices of materials. Wavelength shifters are used to match scintillators to photo-multipliers. Owing to geometrical constraints, wavelength-shifting optical fibers are used [13].

The readout circuit is typically realized by an ASIC that is electrically coupled to the particle sensor. If the ASIC is mounted on a lower surface of the photodiode array, it adds to the overall thickness of the detector module. Moreover, when several such detector modules are stacked to form a detector assembly, the thickness of the ASIC constitutes a dead space between adjacent detector modules that is insensitive to incoming photons.

Present PET instrumentation does not exploit the limits of spatial resolution and detection efficiency as they are set by fundamental physics such as acollinearity of annihilation photons, the finite positron travel path in tissue, and Compton scattering in the tissue. Existing instrumentation has technical limitations such as missing information of depth-of-interaction, limits in intrinsic spatial resolution, and drawbacks inherent to photo-multipliers such as volume, weight, cost per channel, reliability, stability, signal uniformity, and susceptibility to electro-magnetic fields.

### SUMMARY OF THE INVENTION

It is an object of the invention to improve spatial resolution in the tomographic image using crystal arrays with photodiode readout.

This object is achieved in accordance with a broad aspect of the invention by a detector module for detecting discrete photons, the detector module comprising:

a scintillator array having a plurality of scintillator elements each accessible from a major surface of the scintillator array and adapted to produce light upon absorbing a photon;

a photodiode array having a like plurality of photodiode elements each having an active surface optically coupled to a corresponding scintillator element of the scintillator array for receiving said light and producing a respective electrical signal; and

an electronic circuit that is electrically coupled to the photodiode array for receiving and processing said electrical signals;

said detector module being configured so that, in use, photons strike a row of said scintillator elements abutting a first edge of the scintillator array so as to propagate through successive scintillator elements of the scintillator array until they are absorbed.

Thus, according to the invention, the scintillator arrays are oriented such that, in use, photons enter an edge of the scintillator array and continue to interact with downstream elements of the scintillator array until they are absorbed by one of the scintillator elements. When they are absorbed, they give up their energy, either completely or partially, and produce light that is detected by an adjacent photodiode of the photodiode array. By such means, the depth-of-interaction can be measured. This orientation is made possible by using thin photodiode arrays to detect the scintillation light. The photodiodes replace the photo-multipliers conventionally used, where each detector array effectively comprises a bank of mutually adjacent photo-multipliers.

By such means, the invention also reduces the overall volume, and weight of the tomograph compared with the use of photo-multipliers and allows dense packaging of detection modules where each module has small crystal size. The cost per channel for photodiodes is less than the cost per channel for photo-multipliers. The invention improves reliability, and stability over photo-multiplier readout, and can operate in electromagnetic fields and in particular in strong static magnetic fields such as in MRI/NMR instrumentation. A PET combined with MRI/NMR appears technically feasible. Similar application using photo-multipliers was proposed in reference [14]. Operation in a strong static magnetic field reduces the positron travel distance in tissue and thereby improving the spatial resolution. The areas of use are human full body PET, human brain PET, any kind of PET functional imaging in humans and animals. Magnetic fields can be used with silicon photodiodes thus allowing the PET to be combined with MRI instrumentation and opening a new area of multi-modality imaging.

In summary, the innovative ideas associated with the invention are:

1. Scintillator crystal arrays optically coupled to photo-diode arrays. For PET applications the scintillator material should have high light yield (typically more than 50,000 photons/MeV) and a fast response time (typically less than 30 ns).

2. Detection mode-1: Gamma radiation interacts in the scintillators and creates scintillation light. The scintillator light is measured in the photodiodes. For 511-IceV the main modes of interaction in the scintillators are Compton scattering and photo-absorption.

3. Detection mode-2: Gamma radiation interacts in the photo-diode arrays. The charge signal from this interaction is measured directly by the photo-diodes in the readout circuit. For 511-keV the main mode of interaction in silicon photo-diodes is Compton scattering where the signal in the photo-diode is created by means of a Compton electron. Depending on the application one can chose to measure the energy of the Compton electron. By measuring the energy of the Compton electron, spatial resolution can be improved [15].

4. For PET applications the photo-diode array should be processed such that the p-implant(s) face the scintillator array. The photodiode array and the scintillator array are designed such that the diode pitch matches the crystal pitch and one diode matches to one crystal.

5. As mentioned above, the wavelength of emission from scintillator materials having fast and high light output does not ideally match custom photodiodes. Thus, scintillators of the lanthanum halide type with cerium doping such as LaBr₃:Ce and LaCl₃:Ce, which are considered suitable materials, peak at 370 nm. Silicon photodiodes show increased sensitivity at higher wavelengths.

Therefore, the photodiode array should be processed to match the scintillator light wavelength, and the scintillator material should be chosen to emit at wavelengths suitable for the photodiode. One way to do this is disclosed by R. Hartmann et al. in “Ultrathin Entrance Windows for Silicon Drift Detectors” [12], which proposes disposing an ultrathin entrance window on a silicon sensor so that the light is able to penetrate sufficiently deeply into the reverse-biased diode to produce optimum signal.

6. Additionally or alternatively, layers of optical coupling can be placed between scintillators and photodiodes in order to match the wavelength and refractive indices of materials. Such optical coupling may be achieved by the use of frequency-shifting materials as disclosed in U.S. Pat. No. 6,078,052, “Scintillation Detector with Wavelength-shifting Optical Fibers” [13]. Such materials operate to modify the frequency of the incoming high-energy light quanta based so as to produce a different frequency that is more suitable for silicon PIN diodes.

Such layers may be formed of plastic material having a thickness of several microns fixed by glue between the scintillator and the photodiode arrays. It is known that certain fluorescent additives may be used to effect wavelength shifting it is believed to be feasible to insert such fluorescent additives into the glue.

7. Scintillator readout option-1: One side of the scintillator array is optically connected to a photodiode array. The other side of the scintillator array is covered with a reflective material to reflect the scintillator light towards the photo-diode array.

8. Scintillator readout option-2: Two sides of the scintillator array are optically connected to two photodiode arrays. The scintillator array is in between two photodiode arrays. The scintillator light splits between the two photodiode arrays. In this option one measures the position of interaction along the crystal using the signal amplitudes from both sides. This option is useful for long crystals corresponding to thick scintillator arrays. Thick scintillator arrays may be employed to reduce the number of readout channels for the tomographic instrument.

9. The signal from the photo-diodes is measured in an application specific integrated circuit (ASIC). The ASIC is located on an electronic circuit carrier board next to the photodiode array.

10. Photodiode processing option-1: the photodiodes are p-type-implants in n-type-silicon, where the p-implants are pixelated, facing the scintillator. The photodiode pixels are electrically connected to the ASIC by metal tracks and wire-bonds where the metal tracks route from the diode pixels to one edge of the photo-diode array. The metal tracks lie in between diode pixels in order not to prevent the light from illuminating the photodiodes. The metal tracks fan-in on one side of the photo-diode array and allow wire-bonding from the diode to the ASIC.

11. Photo-diode processing option-2: the photo-sensor has one p-type-implant facing the scintillator array. The other side of the photo-sensor is pixelated with n-type-implants. The n-type-inplants are separated (guarded) by thin p-type-implants. The photodiode pixels are electrically connected to pads and metal tracks on the ASIC carrier board. The metal tracks on the ASIC carrier board are routed to the ASIC.

12. A scintillator array, a photodiode array, and an ASIC form a radiation detection module. Several radiation detection modules are stacked above each other to form a radiation detection assembly. A tomograph is assembled out of such assemblies in the form of a conventional polygon ring (a part of an annulus) or in the form of a cylinder. The assemblies are oriented with each scintillator array edge-on facing inside the tomograph and electronics facing outside the tomograph. The orientation of the scintillator array allows the depth-of-interaction to be measured.

13. The scintillator crystals are glued with an epoxy material. Also disposed on all surfaces of each scintillator crystal, except the surface that bounds the photodiode array, are reflecting layers that are directed inward to the respective scintillator crystal and serve to reflect light into the photodiodes. The non-reflecting outer surface of the reflecting layer allows photons to pass therethrough, but blocks light from exiting from the scintillator crystal apart from through the single exposed surface adjacent to the photodiode array. This reduces cross talk between adjacent scintillator crystals, which would otherwise occur if light produced by a first scintillator crystal could exit and re-enter a second scintillator crystal, thus being detected by an incorrect photodiode. The amount of material in between the scintillator crystals and the amount of material in between detection modules is kept to a minimum. The material in between crystals prevents light cross talk and mechanically keeps crystals in place. The material between modules is constituted by the photo-diode array and its carrier board and both of them can be designed very thin compared to the scintillator array. The modules are arranged along the axis of symmetry of the cylinder, along which axis the crystal pitch can be preserved across all modules.

14. The size of the crystals and photo-diodes as well as the number of crystals per module can be chosen according to tomographic and technical requirements. The crystals in the radial direction allow the depth-of-interaction to be measured.

15. The ASIC allows detection of signals above a given threshold [16]. The ASIC also allows measurement of the amount of light from individual crystals and in particular from principal crystals where the light intensity exceeds a chosen threshold. The ASIC also allows measurement of the total amount of light from several crystals [17]. It is possible to sum the amount of light in crystals adjacent to the principal crystal. It is also possible to sum the light along the radial direction. The sum of light is proportional to the photon energy and serves as a measure to accept or reject the interaction for imaging.

16. The electronic carrier board carrying the photo-diode array and the ASIC, also carries additional electronics. The electronics is important to encapsulate the module implementation and correctly interface signals to the system level. The electronics on the module serves for data conversion and trigger decision depending on the application. The data processing on the module enables a very high data acquisition rate on a system level. The electronics on the module serves for monitoring and slow control for the ASIC and photodiode array.

17. The ASIC and electronics on the module generate heat. The proposed assembly and the module orientation facilitate the removal of heat and temperature control.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a pictorial representation of a detector module with scintillator array, silicon photo-diode array, and ASIC readout;

FIGS. 2a to 2d are schematic representations showing different views of the detector module with scintillator array, silicon photodiode array, and ASIC readout;

FIG. 3a to 3d are pictorial and schematic representations showing different views of a detector assembly formed of multiple detector modules;

FIGS. 4 is a pictorial representation of several detector assemblies arranged in a polygon; and

FIGS. 5 and 6 are pictorial representations of several juxtaposed detector assemblies forming an annular detector assembly according to alternative embodiments.

### DETAILED DESCRIPTION OF EXEMPLARY EMBODIMENTS

The drawings illustrate examples of a radiation detection module, and the arrangement of several modules in a package, and the arrangement of several packages in a polygon and cylinder. Specifically, the drawings show the assembly of scintillator arrays and photodiode arrays and readout ASICs with respect to each other. The number of crystals and their aspect ratio are shown as an example, and choices can be made depending on the application and requirements.

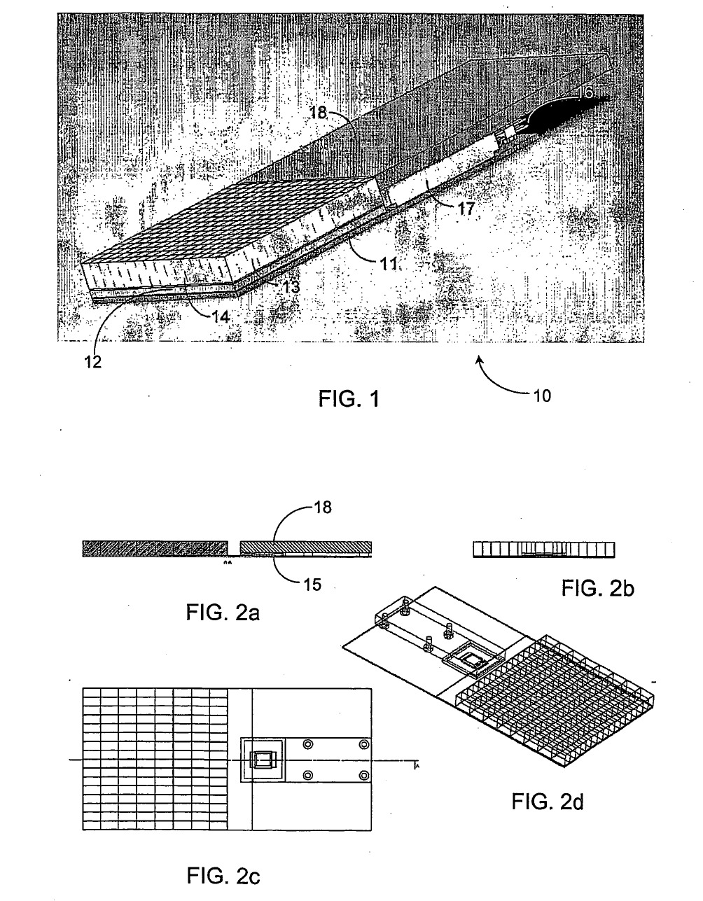

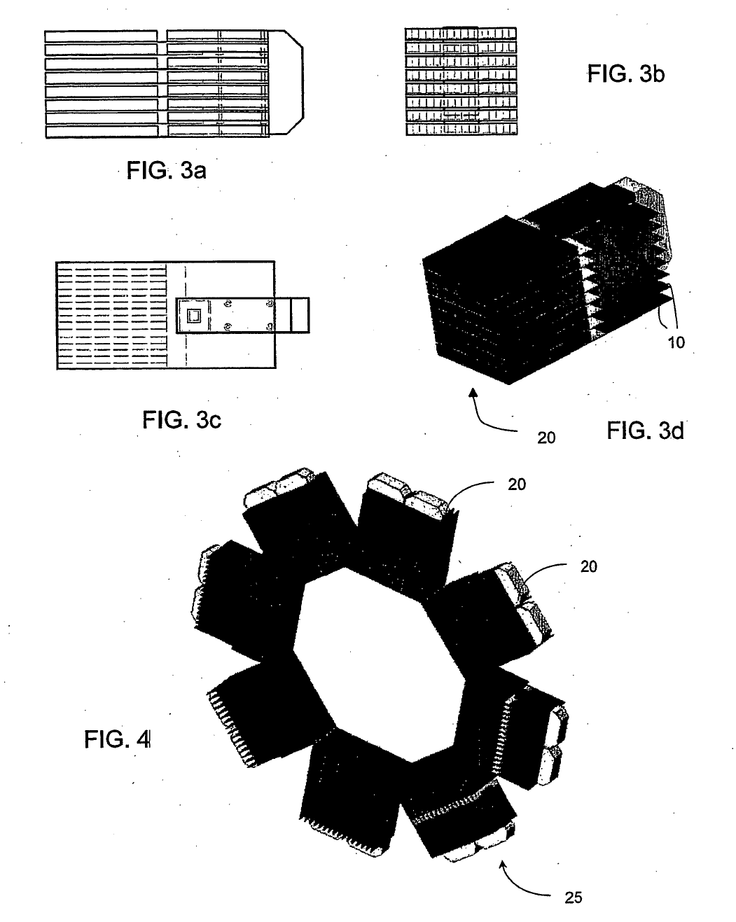

FIGS. 1 and 2a to 2d show respectively pictorial and schematic representations of a detector module depicted generally as 10 having a carrier board 11 on which is mounted a planar silicon photo-diode array 12 juxtaposed to an upper surface of which is mounted a planar scintillator array 13. An exposed edge 14 of the first row of scintillator elements constitutes a first edge of the scintillator array through which photons striking the detector module propagate through successive scintillator elements of the scintillator array until they are absorbed. Also mounted on the carrier board 11 is an ASIC readout circuit 15 (constituting an electronic circuit) that is electrically connected to an edge of the silicon photo-diode array 12 opposite the first edge 14 thereof. Connection pins 16 at an edge of the detector module 10 permit the detector module 10 to be connected to an external data acquisition and controller system and also allow multiple detector modules to be interconnected so as to form a detector assembly as shown in FIGS. 3a to 3d.

The ASIC 15 and associated electronics on the detector module 10 generate heat, which must be dissipated. To this end, the ASIC 15 is mounted underneath a thermally conductive cap 17 on top of which there is mounted a thermally conducting cooling bar 18, constituting a heat sink, which is attached to the cap 17 by means of thermally conductive adhesive. The components may be dimensioned so that the cooling bar is flush with an upper surface of the scintillator array 13. In FIG. 2a , the scintillator array comprises 128 elements arranged in a 16×8 rectangular matrix. The dimension of each crystal on the shorter side of the rectangle is 8 mm on the longer side is 4 mm. Thus, the width of the scintillator array is 8×8=64 mm and its length is 16×4=64 mm. The thickness of each crystal is about 6 mm. The thickness of the silicon photodiode array adds approximately 300 μm, and the carrier adds a further 600 μm. So the overall dimensions of the module 10 are approximately 64 mm×64 mm×7 mm. Moreover, the combined thickness (900 μm) of the carrier and the photodiode array is small compared to the thickness of the scintillator array (6 mm) thereby reducing the fraction of dead space between adjacent detector modules that is insensitive to incoming photons.

FIGS. 3a to 3d are pictorial and schematic representations showing different views of a detector assembly 20 formed of multiple detector modules 10 that are stacked one on top of the other and are interconnected by means of a connector assembly 21 that is connected to the pins 16 of each component detector module.

FIG. 4 shows a PET scanner 25 comprising multiple such detector assemblies 20 juxtaposed to form a ring structure that may be used as a tomograph, for example, where a patient is disposed inside the annular tomograph. The orientation of a module is defined by a normal vector, which is perpendicular to the plane of the scintillator array and photodiode array. In a tomograph, modules can be orientated with normal vectors parallel or perpendicular to the axis of the tomograph.

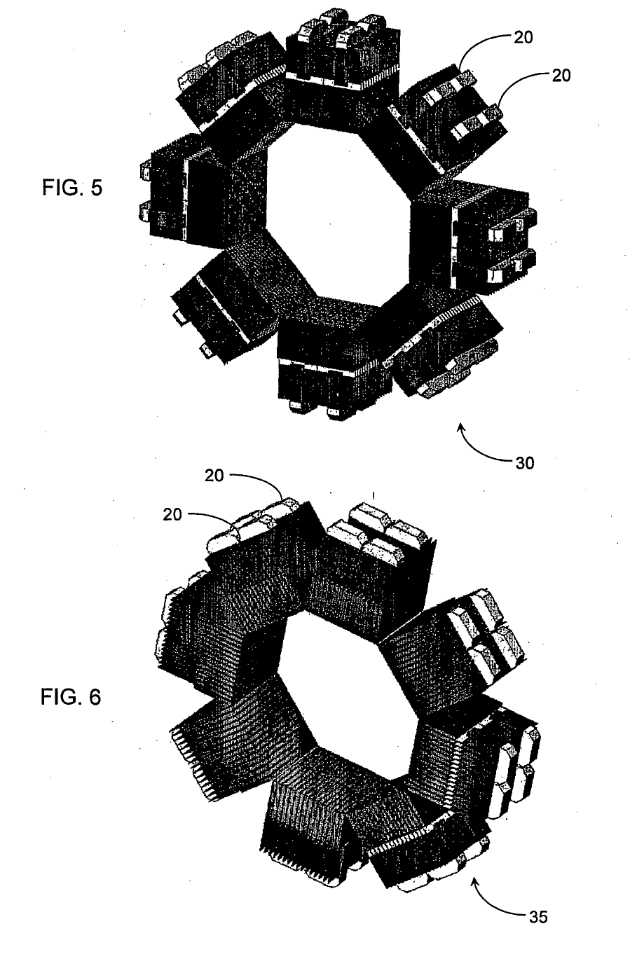

FIGS. 5 and 6 show pictorial representations according to alternative embodiments of several such detector assemblies juxtaposed to form an annular PET scanner suitable for tomography. Thus, FIG. 5 depicts a first annular PET scanner 30 wherein the detector assemblies 20 are oriented axially and FIG. 6 depicts a second annular PET scanner 35 wherein the detector assemblies 20 are oriented in azimuth. Thus, the modules in the detector assembly shown in FIG. 6 are axially rotated through 90° relative to those in FIG. 5. Moreover, in both scanners, two detector assemblies 20 are juxtaposed so as to achieve a composite detector assembly having a larger overall area that is sensitive to photons. If desired, the composite detector may comprise more than two detector assemblies 20 so as to further increase the area of sensitivity to photons. The number of composite detection assemblies surrounding the periphery of the scanner is selected in accordance with the required diameter. A possible application is animal PET, which demands very high spatial resolution, as the animal objects are small. For animal PET a small diameter is adequate, thus requiring only a small number of modules. Another application is human PET where a larger diameter is required, resulting in the need for more modules. The choice can be made according to application and requirements.

In Positron Emission Tomography (PET) a patient is administered a radioisotope that emits positrons (i.e. positively charged electrons). When the positrons meet electrons within the body, the positrons and electrons mutually annihilate and produce two annihilation photons that propagate away from each other at an angle of 180° and are detected by respective detector segments in the PET scanner. The detector segments are constituted by detector assemblies 20. Each of the photons strikes an edge of a respective scintillator array 13 opposite the edge to which the ASIC 15 is connected. Thus, each photon penetrates the bulk of one of the scintillator arrays 13 until it is absorbed by one of the scintillator crystals, thereby emitting light that is detected by an adjacent element in the photodiode array 12, which produces an electric charge that is processed by the ASIC 15. The photodiode element that is struck by light emitted by the scintillator array 13 thus provides direct information about the depth of penetration of the light through the detector. This is in contrast to hitherto-proposed detector assemblies where the photons strike the plane (rather than the edge) of the scintillator array 13; or where the light from a single detector element passes axially through a photo-multiplier.

Moreover, the structure of the detector module in accordance with the invention facilitates a very compact assembly, wherein the fraction of dead space between adjacent detector modules that is insensitive to incoming photons is reduced.

1-10. (canceled)

11. A detector module for detecting depth-of-interaction of discrete photons, the detector module comprising:
a scintillator array having a plurality of scintillator elements each accessible from a surface of the scintillator array and adapted to produce light upon absorbing a photon;
a photodiode array having a like plurality of photodiode elements each having an active surface disposed parallel to said surface of the scintillator array and optically coupled to a corresponding scintillator element of the scintillator array for receiving said light and producing a respective electrical signal; and
an electronic circuit that is electrically coupled to the photodiode array for receiving and processing said electrical signals;
the scintillator array comprising multiple scintillator elements along each axis of a two-dimensional matrix and being configured so that, in use, an incident photon strikes an edge normal to said surface of the scintillator array and propagates through successive scintillator elements until it is at least partially absorbed thus transferring at least some of its energy to a pixel of the photodiode array and providing depth-of-interaction of the photon.

12. The detector module according to claim 11, further including a carrier for supporting the photodiode array and the electronic circuit.

13. The detector module according to claim 12, wherein the carrier is formed of ceramic material.

14. The detector module according to claim 12, wherein:
the electronic circuit is mounted on the carrier so as to abut a second edge of the scintillator array opposite to the first edge thereof; and
a heat sink is mounted on top of the electronic circuit in thermal contact therewith so that the electronic circuit is sandwiched between the carrier and the heat sink.

15. The detector module according to claim 14, wherein the heat sink is dimensioned so that an upper surface thereof is flush with an upper surface of the scintillator array.

16. The detector module according to claim 11, wherein the discrete photons have substantially identical energies.

17. The detector module according to claim 16, wherein the energy of each discrete photon is substantially 511 keV.

18. A detector assembly comprising at least two stacked detector modules according to claim 12.

19. The detector assembly according to claim 18, wherein a combined thickness of the carrier and the photodiode array is less than a thickness of the scintillator array thereby reducing dead space between adjacent detector modules that is insensitive to incoming photons.

20. A composite detector assembly comprising two or more detector assemblies according to claim 18 juxtaposed so as to produce a larger overall area that is sensitive to photons.

21. A scanner for a tomograph, said scanner comprising a plurality of detector assemblies according to claim 19 juxtaposed edge to edge so as to form a ring structure.

22. The scanner according to claim 21, wherein the detector assemblies are orientated such that a normal through a plane of the scintillator array is collinear with an axis of the ring structure.

23. The scanner according to claim 21, wherein the detector assemblies are orientated such that a normal through a plane of the scintillator array is orthogonal to an axis of the ring structure.

24. The scanner according to claim 21, being configured for PET tomography.
